(19) United States
(12) Patent Application Publication
(10) Pub. No.: US 2025/0070407 A1
(43) Pub. Date: Feb. 27, 2025

(54) BATTERY CELL WITH ALIGNED EXTENSIONS

(71) Applicant: Rivian IP Holdings, LLC, Irvine, CA (US)

(72) Inventors: Meng WANG, Pleasanton, CA (US); Daniel Matthew DAVIES, San Francisco, CA (US); Debaditya BISWAS, San Jose, CA (US); Kenton Robert HARRIS, Bloomington, IL (US)

(21) Appl. No.: 18/454,762

(22) Filed: Aug. 23, 2023

(51) Int. Cl. H01M 50/533; H01M 10/0587; H01M 50/536

(52) U.S. Cl. CPC H01M 50/533; H01M 10/0587; H01M 50/536; H01M 2220/20

(57) ABSTRACT

Aspects of the disclosure relate to a battery cell that includes a rolled electrode layer having a coated region, and multiple uncoated extensions that are radially aligned with each other, such as along a direction extending radially from a center of the rolled electrode layer.

### INTRODUCTION

Batteries are often used as a source of power, including as a source of power for electric vehicles that include wheels that are driven by an electric motor that receives power from the battery.

Aspects of the subject technology can help to improve the efficiency and range of electric vehicles, which can help to mitigate climate change by reducing greenhouse gas emissions

### SUMMARY

Aspects of the subject disclosure relate to an electrode for a cylindrical battery cell, the electrode having multiple uncoated extensions that align with each other when the electrode is rolled. The aligned extensions can then be connected to a tab. Providing a cylindrical cell with aligned tabs in this way can provide improvements over single tab, multiple tab, and tabless designs for cylindrical cells. In one or more implementations, multiple uncoated extensions are spaced apart by increasing distances along the electrode, so that the uncoated extensions will align when the electrode is rolled. The multiple uncoated extensions may increase in height as the distance from the tab increases, to allow the uncoated extensions to be folded over into contact with the other, aligned, uncoated extensions (and/or with the tab) after rolling. The multiple uncoated extensions may also increase in width as the distance from the tab increases, to provide increase tolerance for rolling variations.

In accordance with aspects of the disclosure, an apparatus is provided that includes: an electrode layer having a coated region and a plurality of uncoated extensions spaced apart along an edge of the coated region. A first one of the plurality of uncoated extensions has a first size and wherein a second one of the uncoated extensions has a second size different from the first size. The first size may include a first width along a direction parallel to the edge of the coated region and the second size may include a second width along the direction parallel to the edge of the coated region. The first size may include a first height along a direction perpendicular to the edge of the coated region and the second size may include a second height along the direction perpendicular to the edge of the coated region.

In one or more implementations, the apparatus may also include a tab connected to an uncoated region of the electrode layer. The first one of the plurality of uncoated extensions may be a nearest uncoated extension to the tab, the second one of the plurality of uncoated extensions may be spaced apart from the first one of the plurality of uncoated extensions by a first distance, and a third one of the plurality of uncoated extensions may be spaced apart from the second one of the plurality of uncoated extensions by a second distance greater than the first distance.

In one or more implementations, the apparatus may also include a tab connected to an uncoated region of the electrode layer. The first one of the plurality of uncoated extensions and the second one of the plurality of uncoated extensions may be disposed on a first side of the electrode layer with respect to the tab, and the plurality of uncoated extensions may also include, on a second side of the electrode layer with respect to the tab, a third one of the plurality of uncoated extensions having first size and a fourth one of the uncoated extensions having the second size.

The plurality of uncoated extensions may be spaced apart, along the edge of the coated region by increasing distances configured to align the plurality of uncoated extensions with each other when the electrode layer is in a rolled configuration. The plurality of uncoated extensions may be configured to be folded over into contact with each other when the electrode layer is in the rolled configuration. The electrode layer may include an anode layer or a cathode layer for a battery cell. The electrode layer may be implemented in a battery cell in a vehicle.

In accordance with other aspects of the disclosure, a battery cell may be provided with a rolled electrode layer having a coated region and a plurality of uncoated extensions that are radially aligned with each other along a direction extending radially from a center of the rolled electrode layer. The plurality of uncoated extensions may be folded into contact with each other. The plurality of uncoated extensions may be welded to a tab that extends from an uncoated region of the rolled electrode layer. The tab may be electrically coupled to an external terminal of the battery cell. The tab may be electrically coupled to the external terminal via a weld to a cap of the battery cell.

In accordance with other aspects of the disclosure, a method is provided that includes obtaining an electrode layer having a coated region and a plurality of uncoated extensions spaced apart along an edge of the coated region; and rolling the electrode layer to radially align the plurality of uncoated extensions along a direction extending radially from a center of the electrode layer upon completion of the rolling. A first one of the plurality of uncoated extensions may have a first size and a second one of the uncoated extensions may have a second size different from the first size. The method may also include folding the plurality of uncoated extensions that are radially aligned into contact with each other. The method may also include welding at least one of the plurality of uncoated extensions to a tab that is electrically connected to an uncoated region of the electrode layer. The method may also include providing the electrode layer in a cylindrical housing for a battery cell.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 3 illustrates an example of a single tab electrode, in an unrolled configuration, for a battery cell in accordance with one or more implementations.

FIG. 4 illustrates an example of a tabless electrode, in an unrolled configuration, for a battery cell in accordance with one or more implementations.

FIG. 5 illustrates an example of a multi-tab electrode, in an unrolled configuration, for a battery cell in accordance with one or more implementations.

FIG. 6 illustrates an example of an electrode with aligned uncoated extensions in an unrolled configuration in accordance with one or more implementations.

FIG. 7 illustrates a top perspective view of a partially assembled cylindrical cell, including the electrode of FIG. 6 in a rolled configuration with aligned tabs, in accordance with one or more implementations.

FIG. 8 illustrates another example of an electrode with aligned uncoated extensions in an unrolled configuration in accordance with one or more implementations.

FIG. 9 illustrates a top perspective view of a partially assembled cylindrical cell, including the electrode of FIG. 8 in a rolled configuration with aligned tabs, in accordance with one or more implementations.

FIG. 10 illustrates another example of an electrode with aligned uncoated extensions in an unrolled configuration in accordance with one or more implementations.

FIG. 11 illustrates a top perspective view of a partially assembled cylindrical cell, including the electrode of FIG. 10 in a rolled configuration with aligned tabs, in accordance with one or more implementations.

FIG. 12 illustrates a flow chart of illustrative operations that may be performed for manufacturing a battery cell with aligned extensions in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to an electrode for a battery cell such as a cylindrical battery cell, the electrode having multiple uncoated extensions that align with each other when the electrode is rolled, for connection to a tab and/or an external terminal.

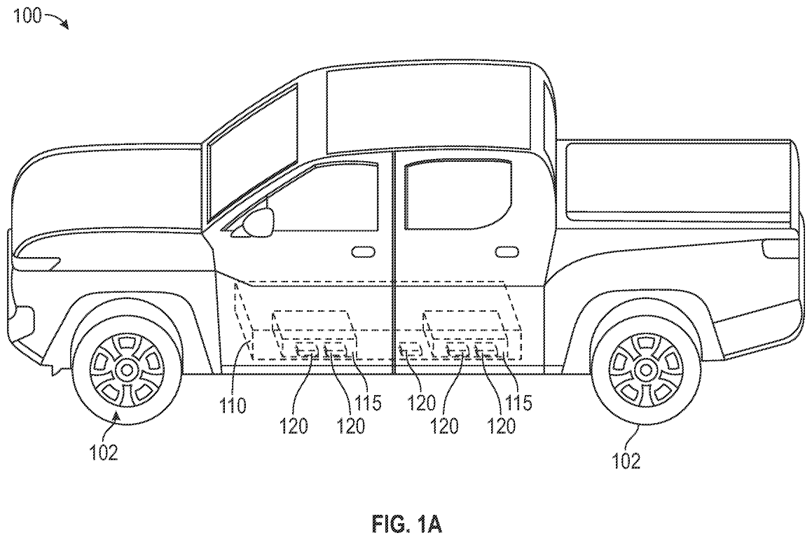

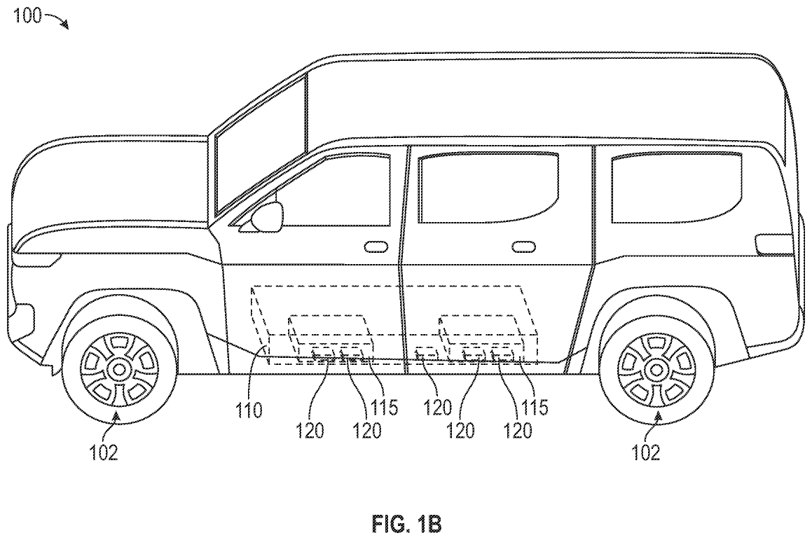

FIG. 1A is a diagram illustrating an example implementation of an apparatus as described herein. In the example of FIG. 1A, the apparatus is a moveable apparatus implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

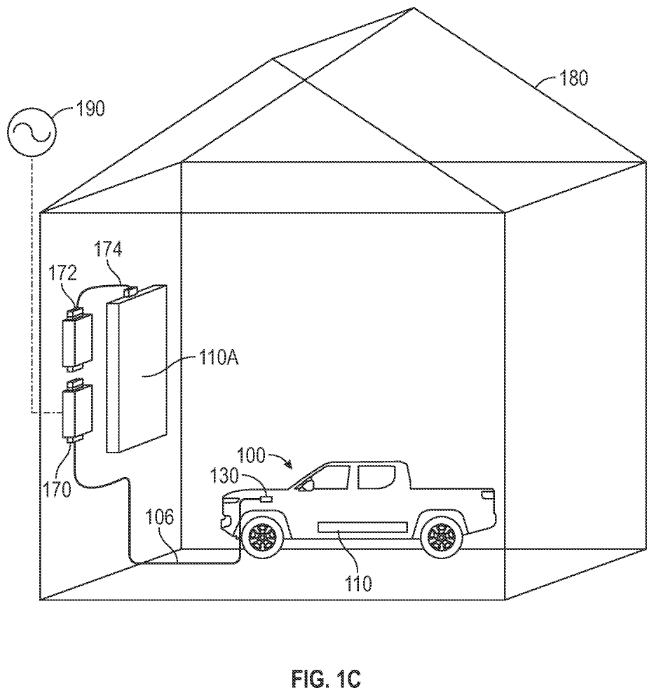

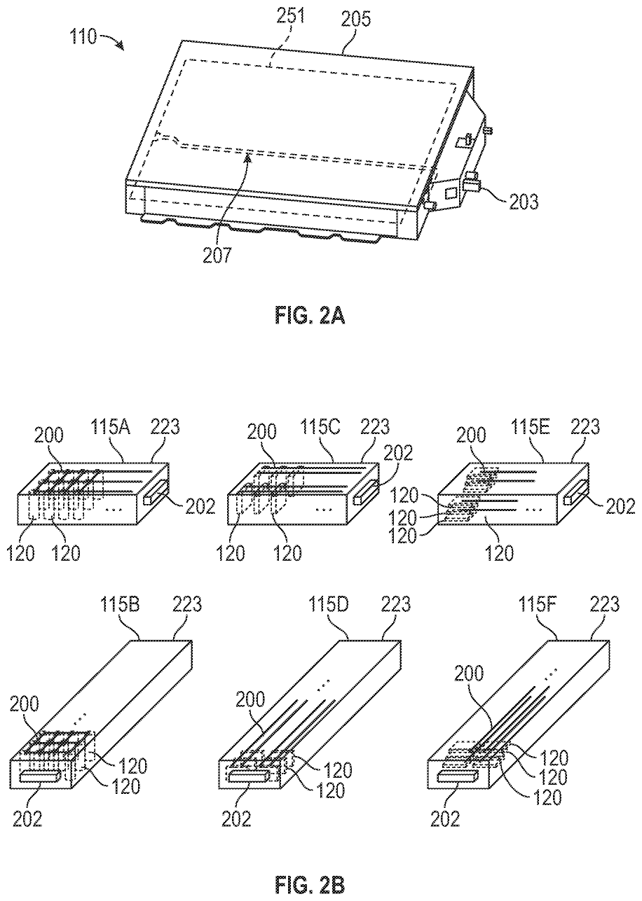

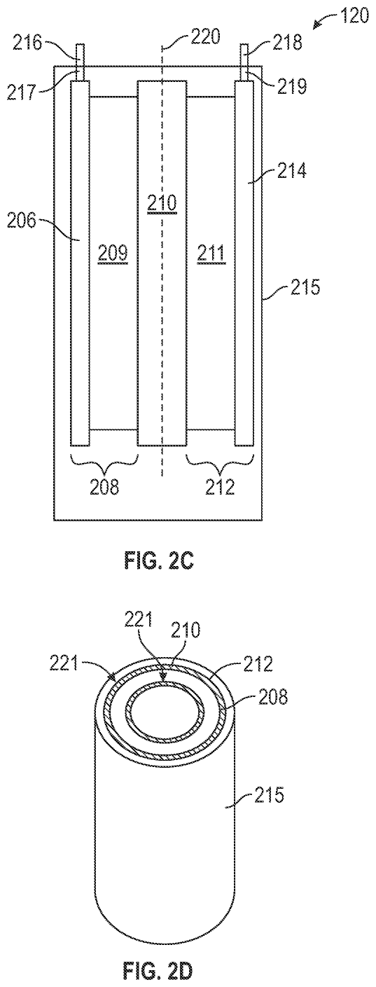

FIG. 2A depicts an example battery pack 110. Battery pack 110 may include multiple battery cells 120 (e.g., directly installed within the battery pack 110, or within batteries, battery units, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired output voltage for the battery pack 110. The battery pack 110 may also include one or more external connection ports, such as an electrical contact 203 (e.g., a high voltage terminal). For example, an electrical cable (e.g., cable/connector 106) may be connected between the electrical contact 203 and an electrical system of the vehicle 100 or the building 180, to provide electrical power to the vehicle 100 or the building 180.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules 115, battery units, batteries, and/or battery cells 120 within the battery pack frame 205, such as by distributing fluid through the battery pack 110.

For example, the thermal control structures 207 may form a part of a thermal/temperature control or heat exchange system that includes one or more thermal components 251 such as plates or bladders that are disposed in thermal contact with one or more battery modules 115 and/or battery cells 120 disposed within the battery pack frame 205. For example, a thermal component 251 may be positioned in contact with one or more battery modules 115, battery units, batteries, and/or battery cells 120 within the battery pack frame 205. In one or more implementations, the battery pack 110 may include one or multiple thermal control structures 207 and/or other thermal components for each of several top and bottom battery module pairs. As shown, the battery pack 110 may include an electrical contact 203 (e.g., a high voltage connector) by which an external load (e.g., the vehicle 100 or an electrical system of the building 180) may be electrically coupled to the battery modules and/or battery cells in the battery pack 110.

FIG. 2B depicts various examples of battery modules 115 that may be disposed in the battery pack 110 (e.g., within the battery pack frame 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the battery pack frame 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the battery pack frame 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the battery pack frame 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the battery pack frame 205) may include or define a plurality of structures for positioning of the battery cells 120 directly within the battery pack frame 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). For example, an anode material 209 may be coated on a region of a surface of the current collector 206 to form the anode 208. As shown, the cathode 212 may include or be electrically coupled to a second current collector 214 (e.g., a metal layer such as a layer of aluminum foil or other metal foil). For example, a cathode material 211 may be coated on a region of a surface of the current collector 214 to form the cathode 212.

As shown, the battery cell 120 may include a first terminal 216 (e.g., a negative terminal) coupled to the anode 208 (e.g., coupled to the first current collector 206 via a tab 217) and a second terminal 218 (e.g., a positive terminal) coupled to the cathode (e.g., coupled to the second current collector 214 via a tab 219). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode material 209 is an anode active material formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode material 209 may be coated on a metal foil (e.g., a copper foil) corresponding to the first current collector 206. In these lithium ion implementations, the cathode material 211 may be a cathode active material formed from one or more metal oxides (e.g., a lithium cobalt oxide, a lithium manganese oxide, a lithium nickel manganese cobalt oxide (NMC), or the like) and/or a lithium iron phosphate. For example, the cathode material 211 may be coated on a metal foil (e.g., an aluminum foil) corresponding to the second current collector 214. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, lead-acid battery cells, and/or ultracapacitor cells. For example, in a nickel-metal hydride battery cell, the anode material 209 may be formed from a hydrogen-absorbing alloy and the cathode material 211 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode material 209 may be formed at least in part from lithium, the cathode material 211 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing 215. In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

The cell housing 215 may have any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, separator layer 220, and the cathode 212 may be rolled into one or more substantially cylindrical or spiraled windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221.

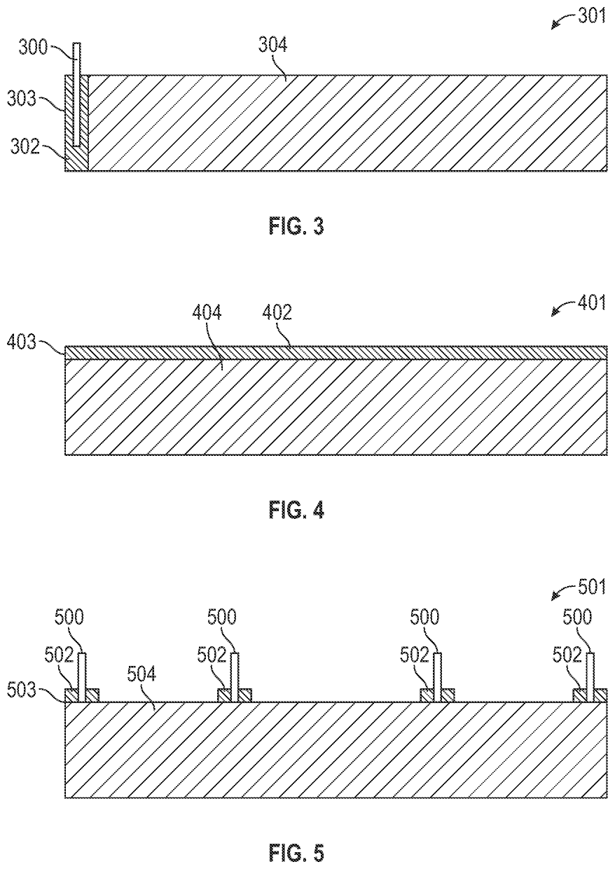

Referring again to FIG. 2C, in order, for example, to connect the anode 208 and the cathode 212, respectively, to the first terminal 216 and the second terminal 218 (e.g., external terminals that are accessible from the outside of the battery cell 120), a battery cell 120, such as the cylindrical cell of FIG. 2D, may be provided with one or more tabs, such as the tab 217 and tab 219 of FIG. 2C, having a first portion that is welded to a current collector of the anode or the cathode. A second portion of each of tabs 217 and 219 may then be welded to the first terminal 216 or the second terminal 218 (e.g., via a cap of the battery cell in some implementations). For example, FIG. 3 illustrates an implementation in which an electrode 301 (e.g., an anode 208 or a cathode 212) for a cylindrical cell includes a single tab 300. As shown, the single tab 300 may be welded to an uncoated region 302 of a current collector 303 (e.g., an implementation of the first current collector 206 or the second current collector 214). As shown, the current collector 303 may also have a coated region 304 that is coated with an electrode material (e.g., anode material 209 or cathode material 211). In the example of FIG. 3, the electrode 301 is shown in an unrolled configuration, and can be rolled (e.g., together with a separator layer and another unrolled electrode) and encased in a cylindrical housing, such as the cell housing 215 of FIG. 2D. As shown, the tab 300 may include a portion that extends beyond an edge of the uncoated region 302 of the current collector 303, and that may be welded to a terminal (e.g., first terminal 216 or second terminal 218), such as terminals on a cap of a cylindrical cell.

However, in the single tab configuration of FIG. 3, in order for charges, such as electrons in the current collector, to travel to the tab 300, the charges in portions of the current collector 303 that are located away from the tab 300 may have a relatively long distance to travel through the current collector 303, which can create an undesirably large impedance for the battery cell. These current conductivity constraints can impede performance of larger diameter and/or taller cells. One option for reducing the path of travel of the charges in the current collector 303 is to provide a tabless electrode 401, with a single elongate uncoated extension 402 that runs along the entire long edge of a current collector 403 having a coated region 404, as shown in FIG. 4. In this configuration of FIG. 4, the entire single uncoated extension 402 may be disposed in contact with a terminal of the battery cell 120. However, in the tabless configuration of FIG. 4, a significant height buffer may be provided at top of the battery cell to accommodate for the volume of the single uncoated extension 402. Such a height buffer may cause a battery cell to have a lower capacity a battery cell without such as height buffer.

Another option for reducing the path of travel of the charges in the current collector 303 is to provide a multi-tab electrode 501, as shown in FIG. 5. In this configuration of FIG. 5, the electrode 501 includes multiple uncoated extensions 502 of a current collector 503 that includes a coated region 504. In the example of FIG. 5, multiple tabs 500 are welded, respectively, to the multiple uncoated extensions 502, and each of the multiple tabs 500 may be welded to a terminal of the battery. In the example of FIG. 5, each of the multiple uncoated extensions 502 is the same size, same width, and same height, and the multiple uncoated extensions 502 are evenly spaced apart from each other on the edge of the current collector 503. In the multi-tab configuration of FIG. 5, assembling the battery cell may include a complex welding assembly process, with significant electrode surface area used for welding the multiple tabs 500, leading to a lower capacity battery cell, and/or yield and/or quality issues in the manufacturing process.

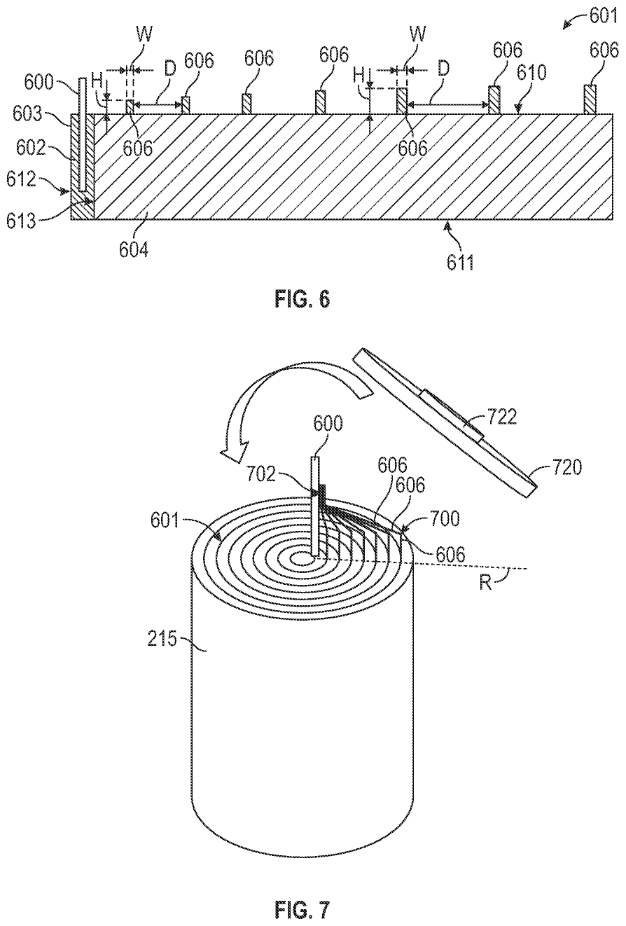

In accordance with aspects of the subject disclosure, an electrode (e.g., a cathode or an anode) is provided with multiple uncoated extensions that align with each other when the electrode is in a rolled configuration. These multiple uncoated extensions may be folded into contact with each other and/or with a tab. For example, FIG. 6 illustrates an example electrode 601. As shown in FIG. 6, the electrode 601 includes a current collector 603 (e.g., an implementation of the first current collector 206, such as a copper foil, or the second current collector 214, such as an aluminum foil, of FIG. 2C). As shown, the current collector 603 has a coated region 604 that is coated with a material, such as the anode material 209 or the cathode material 211 of FIG. 2C. As shown, the coated region 604 may be a substantially rectilinear coated region in some implementations.

The current collector 603 may also include an uncoated region 602 along an edge 612 of the current collector 603 (e.g., extending from an edge 613 of the coated region 604). As shown, a tab 600 (e.g., an implementation of the tab 217 or the tab 219 of FIG. 2C) may be coupled (e.g., welded and in electrical contact) to the uncoated region 602. In the example of FIG. 6, the tab 600 extends, in a direction parallel to the edge 612, beyond an edge 610 (e.g., an edge that is perpendicular to the edge 612) of the current collector 603. As shown, the edge 610 may coincide with an edge of the coated region (e.g., an edge 610 of the coated region 604 that is perpendicular to the edge 613 of the coated region 604).

As shown, the electrode 601 may include multiple uncoated extensions 606, each extending from the edge 610 of the coated region 604. The uncoated extensions 606 and the uncoated region 602 may all be uncoated portions of a contiguous conductive layer (e.g., a metal foil, as described herein). For example, the electrode 601 may be formed, at least in part, by providing the coating material on a portion of a metal foil while leaving uncoated portions along the edge 612 and the edge 610, and then cutting (e.g., with laser or other cutting device) away portions of the uncoated portion along the edge 610 to form the distinct uncoated extensions 606. As shown, the uncoated extensions 606 may extend from the edge 610 and may be separated from an opposing edge 611 of the electrode 601 by the coated region 604, whereas the uncoated region 602 may, in one or more implementations, extend from the edge 610 to the edge 611.s

In one or more implementations the uncoated extensions 606 may be sized and positioned such that, when the electrode 601 of FIG. 6 is rolled into a rolled configuration, the uncoated extensions 606 are aligned (e.g., along a radius of cylindrical cell) with each other. For example, as shown in FIG. 6, each of the uncoated extensions 606 may have a width, W, (e.g., along the edge 610) and a height, H. (e.g., a distance from the edge 610 in a direction substantially perpendicular to the edge 610). As shown, the size (e.g., the width, W, and/or the height, H) of the uncoated extensions 606 may increase with increasing distance (e.g., along the edge 610) from the tab 600. For example, the height, H, of the uncoated extensions 606 may increase (e.g., proportionally to the increased radius of the resulting rolled electrode at the location of each of the uncoated extension) with increasing distance (e.g., along the edge 610) from the tab 600 to allow the uncoated extensions to be folded over and reach the tab 600, when the electrode 601 is in a rolled configuration. For example, the width, W, may increase (e.g., proportionally to the increased radius of the resulting rolled electrode at the location of each of the uncoated extension) with increasing distance (e.g., along the edge 610) from the tab 600, to provide a tolerance (e.g., to variations in the winding or rolling process) to ensure that, when the uncoated extensions 606 are folded, each overlaps with at least one other folded uncoated extension 606.

As shown in FIG. 6, the spacing between the uncoated extensions 606 may also increase with increasing distance (e.g., along the edge 610) from the tab 600. For example, each uncoated extension 606 may be separated from a neighboring uncoated extension 606 by a distance, D. As shown, the distance, D, may increase with increasing distance (e.g., along the edge 610) from the tab 600. In this way, when the electrode 601 is rolled, the increasing circumference of the already rolled portion (e.g., winding 221) of the electrode 601, combined with the increasing distances, D, cause the uncoated extensions 606 to align (e.g., radially) with each other in the resulting “jelly roll”.

For example, FIG. 7 illustrates an example in which the electrode 601 of FIG. 6 has been rolled into a rolled configuration (e.g., a “jelly roll” configuration) and is disposed in a cylindrical cell housing 215. As shown in FIG. 7, in the rolled configuration, the uncoated extensions 606 align (e.g., along a radius, R). As shown, the aligned uncoated extensions 606 may each then be folded (e.g., at a respective fold 700) into contact with the tab 600. The folded aligned uncoated extensions 606 may then be welded (e.g., at a weld 702) to the tab 600, to form multiple pathways for charges (e.g., electrons) to flow to/from the current collector 603 from/to the tab 600.

In order to align the uncoated extensions 606 as shown, the spacing of the uncoated extensions 606 (e.g., the rate of increase of the distances, D, between the uncoated extensions) may also be based on the thickness and/or number of other layers (e.g., additional electrode layers and/or separator layers) that will be rolled along with the electrode 601 to form the “jelly roll” that is disposed within a cylindrical cell housing 215. For example, the thickness of each layer of the “jelly roll” may contribute to a corresponding increase in the radius of the “jelly roll” at each successive winding of the electrode 601. The distances, D, between the uncoated extensions 606 may increase, along the edge 610, by an amount that is based on a combined thickness of the layers of the unrolled “jelly roll”.

In the example of FIG. 7, it can be seen how the increasing height of the uncoated extensions 606 with increased distance along the electrode 601 from the tab 600 (e.g., as shown in FIG. 6), provides a longer uncoated extension 606 at increasing radial distances from the center of the cylindrical cell, for folding into contact with the tab 600. As illustrated in FIG. 7, a cap 720 may be provided for the cylindrical cell that includes the rolled electrode 601. For example, a free end of the tab 600 to which the uncoated extensions 606 are welded may be welded to the cap 720. In this way, the tab 600 (e.g., and resultingly the uncoated extensions 606 and the current collector 603) may be electrically coupled to a terminal 722 on the cap 720 (e.g., an implementation of the terminal 216 or the terminal 218 of FIG. 2C).

In the example of FIGS. 6 and 7, a single tab 600 is coupled (e.g., welded) to an uncoated region 602 of the current collector 603, at or near an end of the current collector 603. In this example, the sizes (e.g., the heights and the widths) of the uncoated extensions 606, as well as the distances between the uncoated extensions 606, increase monotonically in a single direction moving away from the tab 600. In one or more other implementations, the uncoated region 602 and/or the tab 600 may be located elsewhere on the electrode 601.

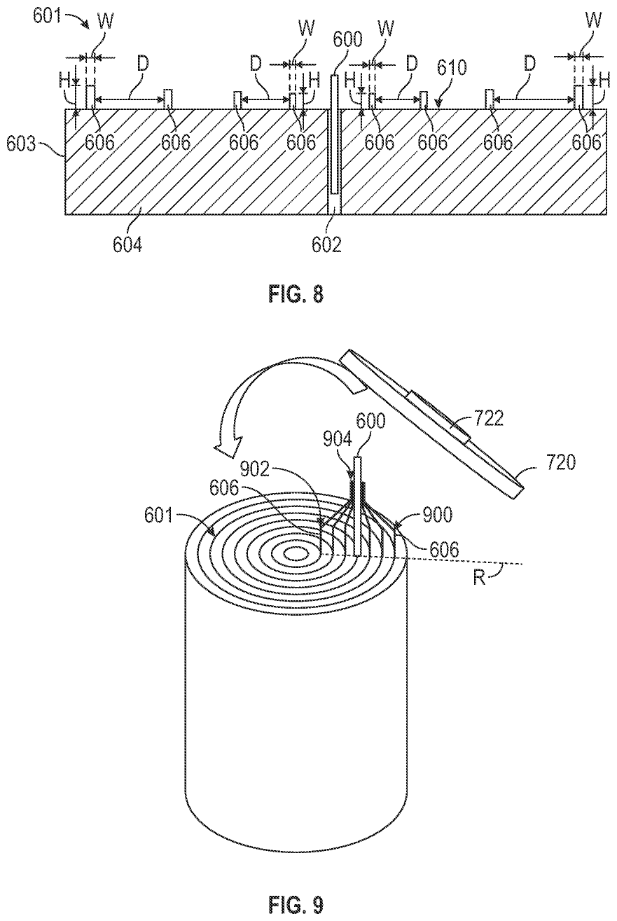

For example, FIG. 8 illustrates another exemplary implementation of the electrode 601, in which the tab 600 is coupled (e.g., welded) to an uncoated region 602 that is located at or near the center of the current collector 603. In this example, the coated region 604 includes two coated subregions that are separated by the uncoated region 602.

In the example of FIG. 8, the sizes (e.g., heights., H, and/or the widths, W) of the uncoated extensions 606 increase with increasing distance, in two opposite directions (e.g., along the edge 610), from the tab 600. In this example, the distances, D, between the uncoated extensions 606 also increase with increasing distance, in two opposite directions (e.g., along the edge 610), from the tab 600.

FIG. 9 illustrates an example in which the electrode 601 of FIG. 8 has been rolled into a rolled configuration (e.g., a “jelly roll” configuration) and is disposed in a cylindrical cell housing 215. As shown in FIG. 9, in the rolled configuration, the uncoated extensions 606 align with each other (e.g., along a radius, R). As shown, the aligned uncoated extensions 606 may each then be folded into contact with the tab 600. In this example, the uncoated extensions 606 on a first side of the tab 600 are folded (e.g., at a fold 900) in first direction toward the tab 600, and the uncoated extensions 606 on a second, opposite, side of the tab 600 are folded (e.g., at a fold 902) in a second, opposite, direction toward the tab 600. As in the example of FIG. 7, the folded aligned uncoated extensions 606 of FIG. 9 may then be welded (e.g., at a weld 904) to the tab 600, to form multiple pathways for charges (e.g., electrons) to flow to/from the current collector 603 from/to the tab 600. As illustrated in FIG. 9, the cap 720 may be provided for the cylindrical cell that includes the rolled electrode 601 of FIG. 9. For example, a free end of the tab 600 at the center of the electrode 601 and to which the uncoated extensions 606 are welded may be welded to the cap 720, and thereby electrically coupled to a terminal 722 (e.g., an implementation of the terminal 216 or the terminal 218 of FIG. 2C).

In various implementations, the electrode 601 of FIGS. 6 and 7 may be implemented as an anode or a cathode of a battery (e.g., depending on the materials of the current collector 603 and the coating that forms the coated region 604). In various implementations, the electrode 601 of FIGS. 8 and 9 may be implemented as an anode or a cathode of a battery (e.g., depending on the materials of the current collector 603 and the coating that forms the coated region 604). In one or more implementations, the electrode 601 of FIGS. 6 and 7 may be implemented as the anode 208 of FIG. 2C and the electrode 601 of FIGS. 8 and 9 may be implemented as the cathode 212 of FIG. 2C.

As illustrated by the examples of FIGS. 6-9, an apparatus, such as battery, a battery cell, a battery subassembly, a battery module, a battery pack, a vehicle, or a building, may include an electrode layer (e.g., electrode 601) having a coated region 604 and multiple uncoated extensions 606 spaced apart along an edge 610 of the coated region 604, in which a first one of the uncoated extensions 606 has a first size and a second one of the uncoated extensions 606 has a second size different from the first size. For example, the first size may include a first width, W, along a direction parallel to the edge 610 of the coated region 604 and the second size may include a second width, W, along the direction parallel to the edge 610 of the coated region 604. As another example, the first size may include a first height, H, along a direction perpendicular to the edge 610 of the coated region 604 and the second size may include a second height, H, along the direction perpendicular to the edge 610 of the coated region 604.

In the example of FIGS. 6 and 7, the apparatus may also include a tab 600 connected to an uncoated region 602 of the electrode layer (e.g., along another edge 613 of the coated region 604), the first one of the uncoated extensions 606 may be a nearest uncoated extension 606 to the tab 600, the second one of the uncoated extensions 606 may be spaced apart from the first one of the uncoated extensions by a first distance, D, and a third one of the uncoated extensions 606 may be spaced apart from the second one of the uncoated extensions by a second distance, D, greater than the first distance, D.

In the example of FIGS. 8 and 9, the apparatus may also include a tab 600 connected to an uncoated region 602 of the electrode layer, the first one of the uncoated extensions 606 and the second one of the uncoated extensions 606 may be disposed on a first side of the electrode layer with respect to the tab 600, and the uncoated extensions may also include, on a second side of the electrode layer with respect to the tab 600, a third one of the uncoated extensions 606 having the first size and a fourth one of the uncoated extensions having the second size. For example, as in FIG. 8, the two uncoated extensions 606 nearest to the tab 600, and on opposite sides of the tab 600, may have the same size (e.g., the same width and the same height), and the other uncoated extensions 606, further from the tab 600 than the two nearest uncoated extensions) on both sides of the tab 600, may each have a size (e.g., a width and a height) that is greater than the size of the two uncoated extensions 606 nearest to the tab 600.

As shown in the examples of FIGS. 7 and 9, the uncoated extensions 606 are spaced apart, along the edge 610 of the coated region 604 by increasing distances, D, configured to align the plurality of uncoated extensions with each other when the electrode layer is in a rolled configuration. As shown in the examples of FIGS. 7 and 9, the uncoated extensions are configured to be folded over into contact with each other (e.g., and with the tab 600) when the electrode layer is in the rolled configuration.

As illustrated by the examples of FIGS. 7 and 9, an apparatus, such as battery, a battery cell, a battery subassembly, a battery module, a battery pack, a vehicle, or a building, may include a rolled electrode layer (e.g., electrode 601) having a coated region 604 and a multiple uncoated extensions 606 that are radially aligned with each other along a direction (e.g., a radial direction, R) extending radially from a center of the rolled electrode layer. In one or more other implementations, the multiple uncoated extensions 606 may be aligned with each other along a direction (e.g., along a substantially straight line) other than a radial direction with respect to the center of the rolled electrode layer. As illustrated by the examples of FIGS. 7 and 9, the multiple uncoated extensions 606 may be folded into contact with each other (e.g., and/or into contact with a tab 600). For example, the multiple uncoated extensions 606 may be welded to a tab 600 that extends from an uncoated region 602 of the rolled electrode layer. The tab may be electrically coupled to an external terminal (e.g., terminal 722, such as an implementation of the terminal 216 or the terminal 218) of the battery cell. For example, the tab 600 may be electrically coupled to the external terminal via a weld to a cap 720 of the battery cell.

In the examples of FIG. 6-9, each electrode 601 includes a single tab 600 coupled to a single uncoated region 602. However, in one or more other implementations, the electrode 601 having the multiple uncoated extensions 606 with increasing sizes and inter-extension spacings. as in any of the examples of FIGS. 6-9, may be provided with multiple tabs 600 coupled to multiple uncoated regions 602 at various locations along the electrode 601. In these other implementations, the electrode 601 may be provided with a number of tabs 600 that is less than the number of uncoated extensions 606, such that each uncoated extension 606 is folded into contact with (e.g., and welded to) a single one of the multiple tabs 600, and such that multiple uncoated extensions 606 are folded into contact with (e.g., an welded to) each of the tabs 600. In these other implementations, the sizes and inter-extension spacings of each of several subsets of the uncoated extensions may increase with increasing distance from the tab 600 to which that subset of the uncoated extensions is configured to be coupled (e.g., welded).

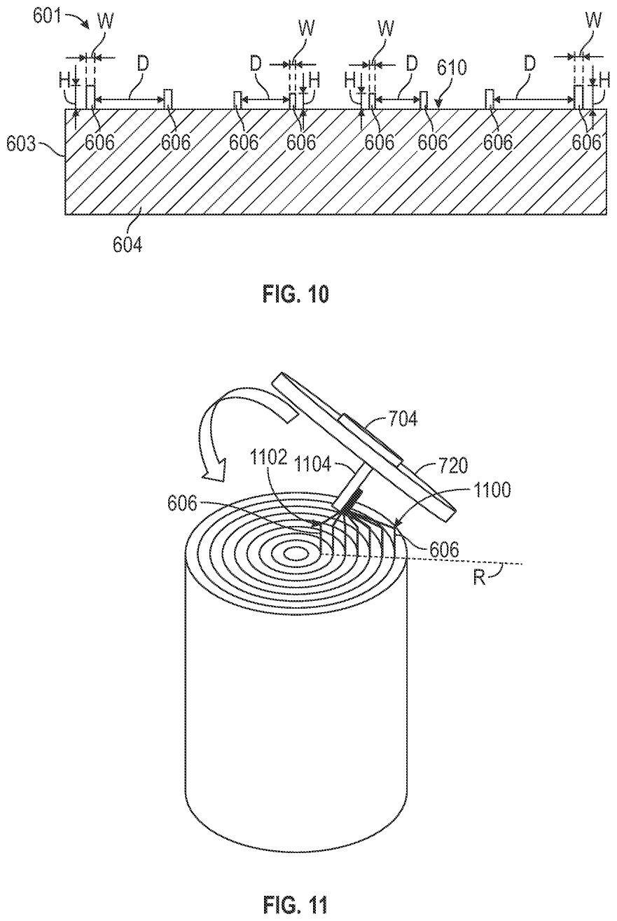

FIG. 10 illustrates yet another implementation of the electrode 601. In the example of FIG. 10, the electrode 601 is provided with multiple uncoated extensions of varying size and inter-extension spacing, and without any tabs 600. In this example, the electrode 601 is provided without an uncoated region 602 at the end or the center of the current collector 603. In this example, the coated region 604 spans substantially the entire surface the current collector 603 except for the uncoated extensions 606 along the edge 610 of the coated region 604. In this example, the sizes (e.g., heights, H, and/or widths, W) of the uncoated extensions 606 increase with increasing distance, in two opposite directions (e.g., along the edge 610), from the center of the electrode 601. In this example, the distances, D, between the uncoated extensions 606 also increase with increasing distance, in two opposite directions (e.g., along the edge 610), from the center of the electrode 601.

FIG. 11 illustrates an example in which the electrode 601 of FIG. 10 has been rolled into a rolled configuration (e.g., a “jelly roll” configuration) and is disposed in a cylindrical cell housing 215. As shown in FIG. 11, in the rolled configuration, the uncoated extensions 606 align (e.g., along a radius, R, or other line). As shown, the uncoated extensions 606 on a first side of the tab 600 are folded (e.g., at a fold 1100) in first direction, and the uncoated extensions 606 on a second, opposite, side of the tab 600 are folded (e.g., at a fold 1102) in a second, opposite, direction. As illustrated in FIG. 11, the cap 720 may be provided for the cylindrical cell that includes the rolled electrode 601 of FIG. 10. As shown in FIG. 11, the folded aligned uncoated extensions 606 of FIG. 11 may then be welded to a tab 1104 that extends from (e.g., extruding from) the cap 720 (e.g., that is pre-welded to the cap 720, rather than being welded to an uncoated region 602 of the current collector 603 of the electrode 601), to form multiple pathways for charges (e.g., electrons) to flow to/from the current collector 603 from/to the tab 1104. For example, a free end of the tab 1104 extending from the cap 720 may be welded to the folded uncoated extensions 606, thereby electrically coupling the folded uncoated extensions 606 to a terminal 722 (e.g., an implementation of the terminal 216 or the terminal 218 of FIG. 2C) of the battery cell.

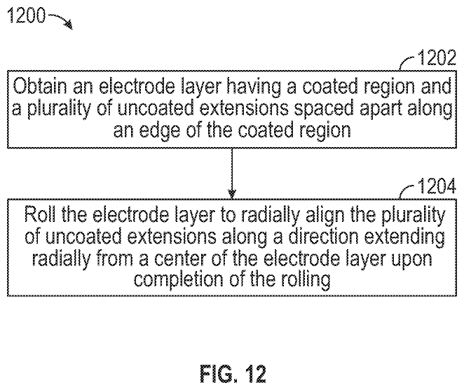

FIG. 12 illustrates a flow diagram of an example process 1200 that may be performed for assembling a battery, in accordance with implementations of the subject technology. For explanatory purposes, the process 1200 is primarily described herein with reference to the electrode 601 and the battery cell 120 of FIGS. 2C and 6-11. However, the process 1200 is not limited to the electrode 601 and the battery cell 120 of FIGS. 2C and 6-11, and one or more blocks (or operations) of the process 1200 may be performed by one or more other structural components of other suitable moveable apparatuses, devices, or systems. Further for explanatory purposes, some of the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

As illustrated in FIG. 12, at block 1202, an electrode layer (e.g., electrode 601) having a coated region (e.g., coated region 604) and a plurality of uncoated extensions (e.g., uncoated extensions 606) spaced apart along an edge (e.g., edge 610) of the coated region may be obtained. In one or more implementations, a first one of the plurality of uncoated extensions has a first size (e.g., a first width, W, and/or a first height, H) and a second one of the uncoated extensions has a second size (e.g., a second width, W, and/or a second height, H) different from the first size.

At block 1204, electrode layer may be rolled to (e.g., radially) align, upon completion of the rolling, the plurality of uncoated extensions along a direction (e.g., a direction, R, or other line), such as a direction extending radially from a center of the electrode layer. In one or more implementations, the process 1200 may also include folding the plurality of uncoated extensions that are (e.g., radially) aligned into contact with each other. In one or more implementations, the process 1200 may also include welding at least one (e.g., two or more, or all) of the plurality of uncoated extensions to a tab (e.g., tab 600) that is electrically connected to an uncoated region (e.g., uncoated region 602) of the electrode layer. In one or more other implementations, the process 1200 may also include welding at least one of the plurality of uncoated extensions to a tab (e.g., tab 1104) that is electrically connected to a cap (e.g., cap 720) for a battery cell.

In one or more implementations, the process 1200 may also include providing the electrode layer in a cylindrical housing (e.g., cell housing 215) for a battery cell (e.g., battery cell 120). In one or more implementations, the process 1200 may also include forming an electrode material (e.g., anode material 209 or cathode material 211) on a current collector (e.g., current collector 603, which may be an implementation of first current collector 206 or second current collector 214) to form the coated region 604. In one or more implementations, the process 1200 may also include cutting an uncoated edge portion of the current collector to form the plurality of uncoated extensions. In one or more implementations, the process 1200 may also include welding the tab to the uncoated region of the current collector. In one or more implementations, rolling the electrode layer at block 1204 may include rolling the electrode layer, a separator layer, and another electrode layer (e.g., which may also include multiple uncoated extensions of varying size and varying spacing, to cause those uncoated extensions to also be aligned with each other upon completion of the rolling).

In one or more implementations, providing a battery cell electrode with uncoated extensions that align with each other when the battery cell is assembled as described herein can provide the same or similar electrochemical performance of multi-tab (e.g., FIG. 5) and tabless (e.g., FIG. 4) designs without incurring a detriment to cell capacity due to reduction of the electrode surface area. In one or more implementations, providing a battery cell electrode with uncoated extensions that align with each other when the battery cell is assembled as described herein can reduce or eliminate manufacturing complexities and/or throughput limitations of multi-tab architectures (e.g., FIG. 5).

Aspects of the subject technology can help improve the efficiency and range of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

1. An apparatus, comprising:
an electrode layer having a coated region and a plurality of uncoated extensions spaced apart along an edge of the coated region, wherein a first one of the plurality of uncoated extensions has a first size and wherein a second one of the uncoated extensions has a second size different from the first size.

2. The apparatus of claim 1, wherein the first size comprises a first width along a direction parallel to the edge of the coated region and wherein the second size comprises a second width along the direction parallel to the edge of the coated region.

3. The apparatus of claim 2, wherein the first size comprises a first height along a direction perpendicular to the edge of the coated region and wherein the second size comprises a second height along the direction perpendicular to the edge of the coated region.

4. The apparatus of claim 1, wherein the first size comprises a first height along a direction perpendicular to the edge of the coated region and wherein the second size comprises a second height along the direction perpendicular to the edge of the coated region.

5. The apparatus of claim 1, further comprising a tab connected to an uncoated region of the electrode layer, wherein the first one of the plurality of uncoated extensions is a nearest uncoated extension to the tab, wherein the second one of the plurality of uncoated extensions is spaced apart from the first one of the plurality of uncoated extensions by a first distance, and wherein a third one of the plurality of uncoated extensions is spaced apart from the second one of the plurality of uncoated extensions by a second distance greater than the first distance.

6. The apparatus of claim 1, further comprising a tab connected to an uncoated region of the electrode layer, wherein the first one of the plurality of uncoated extensions and the second one of the plurality of uncoated extensions are disposed on a first side of the electrode layer with respect to the tab, and wherein the plurality of uncoated extensions further comprise, on a second side of the electrode layer with respect to the tab, a third one of the plurality of uncoated extensions having first size and a fourth one of the uncoated extensions having the second size.

7. The apparatus of claim 1, wherein the plurality of uncoated extensions are spaced apart, along the edge of the coated region by increasing distances configured to align the plurality of uncoated extensions with each other when the electrode layer is in a rolled configuration.

8. The apparatus of claim 7, wherein the plurality of uncoated extensions are configured to be folded over into contact with each other when the electrode layer is in the rolled configuration.

9. The apparatus of claim 1, wherein the electrode layer comprises an anode layer or a cathode layer for a battery cell.

10. The apparatus of claim 1, wherein the electrode layer is implemented in a battery cell in a vehicle.

11. A battery cell, comprising:
a rolled electrode layer having a coated region and a plurality of uncoated extensions that are radially aligned with each other along a direction extending radially from a center of the rolled electrode layer.

12. The battery cell of claim 11, wherein the plurality of uncoated extensions are folded into contact with each other.

13. The battery cell of claim 12, wherein the plurality of uncoated extensions are welded to a tab that extends from an uncoated region of the rolled electrode layer.

14. The battery cell of claim 13, wherein the tab is electrically coupled to an external terminal of the battery cell.

15. The battery cell of claim 14, wherein the tab is electrically coupled to the external terminal via a weld to a cap of the battery cell.

16. A method, comprising:
obtaining an electrode layer having a coated region and a plurality of uncoated extensions spaced apart along an edge of the coated region; and
rolling the electrode layer to radially align the plurality of uncoated extensions along a direction extending radially from a center of the electrode layer upon completion of the rolling.

17. The method of claim 16, wherein a first one of the plurality of uncoated extensions has a first size and wherein a second one of the uncoated extensions has a second size different from the first size.

18. The method of claim 16, further comprising folding the plurality of uncoated extensions that are radially aligned into contact with each other.

19. The method of claim 18, further comprising welding at least one of the plurality of uncoated extensions to a tab that is electrically connected to an uncoated region of the electrode layer.

20. The method of claim 19, further comprising providing the electrode layer in a cylindrical housing for a battery cell.
